(19) United States
(12) Patent Application Publication
(10) Pub. No.: US 2012/0089687 A1
(43) Pub. Date: Apr. 12, 2012

(54) ONLINE MESSAGING SYSTEM AND METHODS OF USING THEREOF

(76) Inventor: EYAL KATZ, KFAR VRADIM (IL)

(21) Appl. No.: 13/269,628

(22) Filed: Oct. 10, 2011

Related U.S. Application Data
(60) Provisional application No. 61/391,696, filed on Oct. 11, 2010.

(51) Int. Cl. G06F 15/16

(52) U.S. Cl. 709/206

(57) ABSTRACT

A bulletin type messaging system for sending messages from a publisher to a multiplicity of interconnected target users. The bulletin messaging system includes a bulletin messaging server, having a processor and database. The database may include a publishers' database and a users' database. The bulletin messaging system further includes a computerized device of a publisher and a computerized device of a user. The bulletin messaging server is in communication flow with the publisher's computerized device and with the user's computerized device. A target user is enlisted to receive messages from one or more particular publishers through the bulletin messaging server. The target user receives a message from a publisher, in real time, upon the posting of a new message by the publisher in the preconfigured location in the database location in the database, wherein the processor sends the posted message.

### RELATED APPLICATION

The present application claims the benefit of U.S. provisional application 61/391,696 filed on Oct. 11, 2010, the disclosure of which is incorporated herein by reference.

### FIELD OF THE INVENTION

The present invention relates generally to bulletin type messaging, and more particularly, to messaging systems and methods for providing a messaging/advertising content over a network and into a dedicated bulletin window slot on the screen of a computerized receiving device of a user, for example, a desktop screen. Each publisher has a bulletin window slot in which window slot only that publisher publishes messages. The bulletin window slot remains on the screen as long as the user wishes to receive messages from the publisher, associated with that window slot.

### BACKGROUND OF THE INVENTION AND PRIOR ART

A vast amount of data and information (referred to generally as “content”) is available via the internet, including the world-wide web. Content can be provided from a correspondingly vast number of sources, generally referred to as “publishers”. Some of the forms which such content may take include web pages, web-sites, search results, emails, chats and the like.

Publishers may allocate delimited spaces on a preconfigured screen design (banners”), into which messages such as advertisements and notifications, having predetermined form, substance, and other characteristics or parameters, are delivered.

In commonly used messaging systems and methods the user which receives the message, has no control as to the message source and content. Furthermore, a publisher typically sends the message to a target public segment.

There is need and it would be advantageous to have a system that facilitates messaging service, in which:
a) A publisher places a message to a specific internet accessible location, allocated by the service provider.
b) A user selects the publishers and/or message types that he/she wants to receive into a designate bulletin window slot on the screen of a receiving device of the user, operatively connected to the internet.
c) The message of a selected publisher that was placed at the specific internet accessible location is automatically displayed inside the designate bulletin window slot on the screen of the receiving device of the selecting user.

Hence, it would be advantageous to have a system that facilitates instantaneous messaging to a large number of designated users. It would be further advantageous to use the system to deliver advertising ads to the well defined group of users.

### SUMMARY OF THE INVENTION

The principal intentions of the present invention include providing a system and method that facilitates messaging methods in which:
a) A publisher places a message to a specific internet accessible location, allocated by a service provider.
b) A user selects the publishers and/or message types that he/she wants to receive into a designate bulletin window slot on the screen of a receiving device of the user, operatively connected to the internet.
c) The message of a selected publisher that was placed at the specific internet accessible location is automatically sent by the system to all enlisted users and displayed inside the designate bulletin window slot on the screen of the receiving device of each selecting user.

An aspect of the present invention is to facilitate a bulletin messaging system for various publishers without having to send the messages as spam mail and without the need to acquire and maintain a large mailing list. A publisher can be a company, an organization, an individual or any other entity. On the receiving end of the bulletin messaging system, a user can select a publisher from which he/she wishes to receive messages, and is not becoming a member of a mailing list, in which typically, the user does not want to be a part of. Typically, the user, although receiving messages from a selected publisher, remains anonymous to that publisher. Hence, typically, the bulletin messaging system is an asymmetric system, in which a user can receive messages from a selected publisher, but cannot send reply or send a message to the selected publisher.

It should be noted that the number of users connected to a particular publisher is practically unlimited, imposing substantially no burden on the publisher. It should be further noted that a user may connect to a multiplicity of publishers.

It should be further noted that, typically, each publisher has a bulletin window slot, for example on a user's desktop, in which window slot only that publisher may publish messages. The bulletin window slot remains on the screen as long as the user wishes to receive messages from the publisher, associated with that window slot.

According to teachings of the present invention, there is provided a bulletin type messaging system for sending messages from a publisher to a multiplicity of interconnected target users. The bulletin messaging system includes a bulletin messaging server, having a processor and database. The database may include a publishers' database and a users' database. The bulletin messaging system further includes a computerized device of a publisher and a computerized device of a user.

The bulletin messaging server is in communication flow with the publisher's computerized device and with the user's computerized device. The bulletin messaging server facilitates a publisher to post a new message at a preconfigured location in the database. The content of a message may be textual data, image data, video data, audio data, a gadget or a mixture thereof.

A target user is enlisted to receive messages from one or more particular publishers through the bulletin messaging server. Typically, the target user is one of a multiplicity of target users of a particular publisher. The target user receives a message from a publisher, in real time, in a designated bulletin window slot on the screen of the user's computerized device, upon the posting of the new message by the publisher in the preconfigured location in the database location in the database, wherein the processor sends the posted message.

The user may place a multiplicity of the bulletin-window-slots on the screen of the user's computerized device, wherein each bulletin-window-slot is operatively coupled with a particular publisher. Optionally, a bulletin-window-slot may be operatively coupled with a few related publishers.

Optionally, the bulletin-window-slot is created using the gadgets application of Windows® and RSS technology.

Optionally, an advertisement may be placed in a preconfigured location within the designated bulletin window slot of one or more selected publishers.

An aspect of the present invention is to provide a method of a user enlisting to receive messages from a selected publisher, the method including the steps of providing messaging system having a bulletin messaging server with a processor and a database, a publisher's computerized device and a user's computerized device. The method further including the steps of searching and selecting a publisher from the database, and creating a bulletin-window-slot for receiving messages from the selected publisher.

The bulletin messaging server is in communication flow with the publisher's computerized device and with the user's computerized device, and the bulletin messaging server facilitates a publisher to post a new message at a preconfigured location in the database.

Typically, the user remains anonymous to the publisher.

Optionally, the publisher requires from the user to enter a password, in order to enlist to view messages posted by the publisher.

Another aspect of the present invention is to provide a method of publishing a message by a particular publisher onto the bulletin-window-slot of a pre-selected group of target users, the method including the steps of providing messaging system having a bulletin messaging server with a processor and a database, a publisher's computerized device and a user's computerized device. The method further including the steps of placing a message in a designated location in the database and sending the message to all enlisted target users by the processor.

The bulletin messaging server is in communication flow with the publisher's computerized device and with the user's computerized device, the bulletin messaging server facilitates a publisher to post a new message at a preconfigured location in the database, and a target user is enlisted to receive messages from one or more particular publishers.

The publisher first registers with the service provider that operates the bulletin messaging server. Typically, the target user also registers with the service provider that operates the bulletin messaging server.

Optionally the particular publisher requires that a password is entered by the target user in order to enlist to view messages posted by the publisher.

Optionally, the particular publisher requires that the target user, enlisting to view messages posted by the particular publisher, be approved by the particular publisher.

Optionally, the particular publisher compensates the service provider that operates the bulletin messaging server, for messaging services rendered.

Optionally, the method further includes a step of placing an advertisement in a preconfigured location within the designated bulletin window slot of the particular publisher. The advertiser of the advertisement may compensate the service provider that operates the bulletin messaging server, or the advertisement may compensate the particular publisher.

Optionally, the advertiser of the advertisement may select parameters of the advertisement according to a predetermined fee schedule, wherein the parameters are selected from a group including ad-type, location within the designated bulletin window slot, font and other esthetic related parameters. The ad-type may be textual data, image data, video data, audio data, a gadget or a mixture thereof.

### BRIEF DESCRIPTION OF THE DRAWINGS

The present invention will become fully understood from the detailed description given herein below and the accompanying drawings, which are given by way of illustrations and examples only and thus not limitative of the present invention, and wherein:

FIG. 1 is a schematic illustration of a bulletin messaging system, according to embodiments of the present invention;

FIG. 2 is a schematic flow chart showing an example method of a publisher registering, uploading and/or managing one or more messages to the bulletin messaging system, according to embodiments of the present invention;

FIG. 3 is a schematic flow chart showing an example method of a user registering, selecting one or more publishers available on the bulletin messaging system, and downloading and installing a bulletin window slot of the selected publisher, according to embodiments of the present invention;

FIG. 4 shows an example home screen of a messaging service provider, according to variations of the present invention;

FIG. 5 shows an example screen of a particular publisher, open to the public, according to variations of the present invention; and

FIG. 6 shows an example bulletin window slot of a selected publisher, according to variations of the present invention.

### DETAILED DESCRIPTION OF THE PRESENT INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

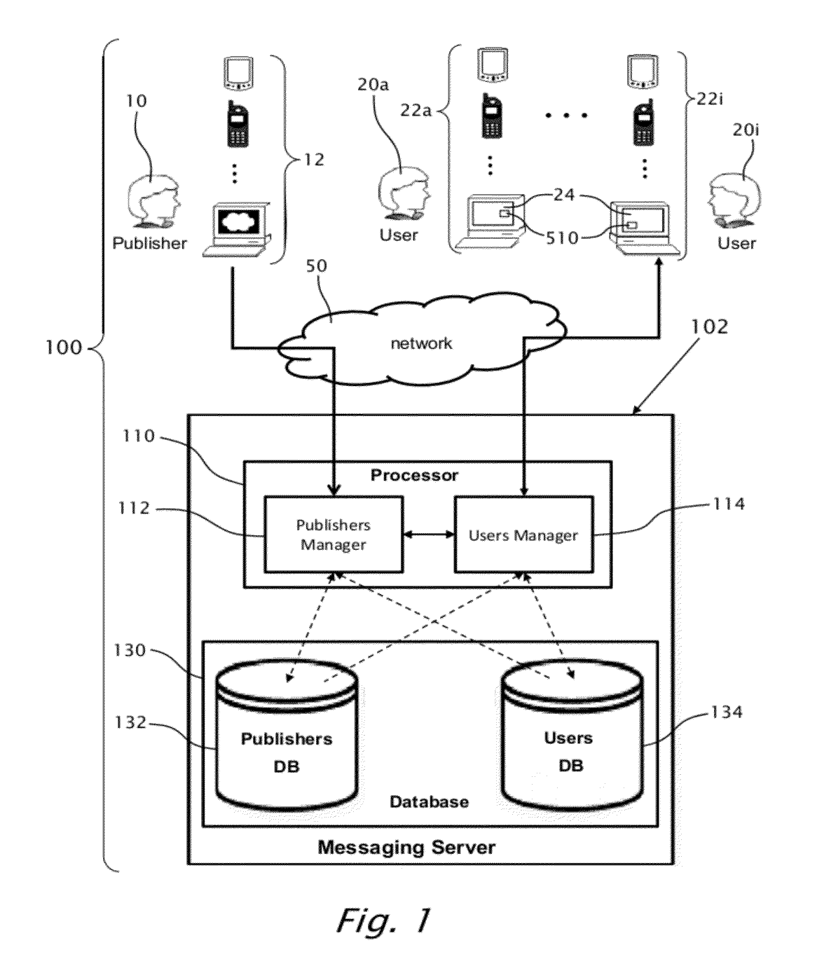

The system of the present invention provides a bulletin type messaging/advertisement. Reference is now made to FIG. 1, which is a schematic illustration of a bulletin messaging system 100, according to embodiments of the present invention. Bulletin type messaging/advertisement system 100 is a messaging-server 102, operatively connected to the internet. Messaging-server 102 including a publishers' management unit 112, a users' management unit 114 and database (DB) unit 130. Database unit 130 includes a publishers' DB region 132 and a users' DB region 134.

To receive a message from a publisher 10, a user 20 has a receiving device 22, operatively connected to the internet is operationally connected to messaging server 102, typically, via users' management unit 114 and over a network 50, such as an internet network, a cellular network or any other network. Messaging server 102 includes a messaging bulletin-window-slot 510, installed, designated for messages of a particular publisher 10, installed by user 20 on display 24 of receiving device 22.

A publisher 10, that wishes to publish messages to a multiplicity of users 20, log into messaging server 102 over a network 50, such as an internet network, a cellular network or any other network, and places a message in a designated location in DB 130, typically in publishers' DB region 132, and typically via publishers' management unit 112. As a particular publisher 10 publishes a message onto the designated location in DB 130, the message will appear, substantially immediately (depending, for example, on the network transmitting speed and on the performance of the host receiving devices 22) in the respective designated messaging bulletin-window-slot 510 of all users 20 having a messaging bulletin-window-slot 510 of that particular publisher 10, installed on the respective receiving devices 22. Hence, to place a message in a designated messaging bulletin-window-slot 510 on screen 24 of receiving devices 22 of all users 20, pre-selected to receive messages from that particular publisher 10, publisher 10 simply places a message in a designated location in DB 130.

It should be noted that a particular registered publisher may open more than one channel of messaging. For example, the spokesman of New-York city may open one channel for general municipality related information; another channel for cultural related information; another channel for education related information, etc.

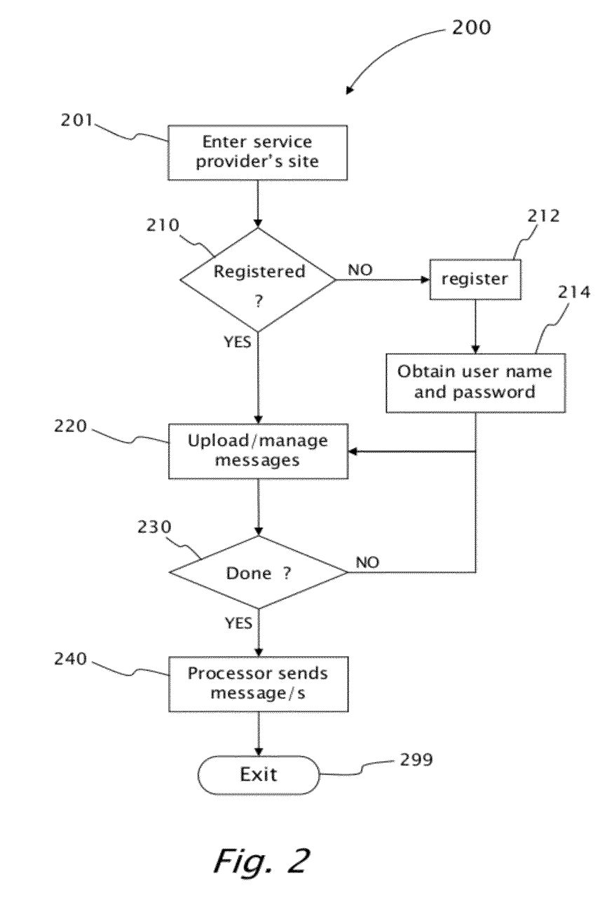

Reference is now made to FIG. 2, showing an example method 200 of a publisher 10 registering, uploading and/or managing one or more messages to bulletin messaging system 100, according to embodiments of the present invention. Publisher 10 enters bulletin messaging system 100 in step 201, in order to upload one or more messages into DB 130 of bulletin messaging system 100, or in order to update manage or edit one or more messages in DB 130. Typically, if publisher 10 is not a registered user of the services provided by bulletin messaging system 100 (step 210), publisher 10 may register in step 212 and obtain a user name and optionally a password, in step 214.

Once publisher 10 is registered and logged into bulletin messaging system 100, process 200 proceeds as follows:
Step 220: upload/manage a message.
   Publisher 10 uploads a new message into DB 130 and/or updates, and/or manages, and/or edits one or more existing messages in DB 130, typically via publishers' management unit 112.
   When posting a new message, publisher 10 places a message in a designated location in DB 130. The message, substantially immediately, appears in the bulletin-window-slot 510 on screen 24 of the receiving devices 22 of all users 20, pre-selected to receive messages from that particular publisher 10, provided that the receiving devices 22 are operatively connected to the internet.
   Publisher 10 may allow a user 20 to receive posted messages the following degrees of permission restrictions:
      a) No restrictions, being the preferred mode.
      b) Entering a common password.
      c) Entering a unique user name and password.
   When no restrictions are imposed by a particular publisher 10, a user 20, selecting to receive messages from that particular publisher 10 remains anonymous to that publisher.
   When both a unique user name and password are required, a user 20, selecting to receive messages from that particular publisher 10, becomes known to that publisher.
Step 230: determine if publisher 10 wants to add/manage another message.
   If publisher 10 wants to add/manage another message, go to step 220.
Step 240: processor sends message/s.
   Processor 110 sends to all enlisted target users of publisher 10 message/s placed in the designated location in DB 130. The message, substantially immediately, appears in the bulletin-window-slot 510 on screen 24 of the receiving devices 22 of all users 20, pre-selected to receive messages from that particular publisher 10, provided that the receiving devices 22 are operatively connected to the internet.
   Exit (step 299).

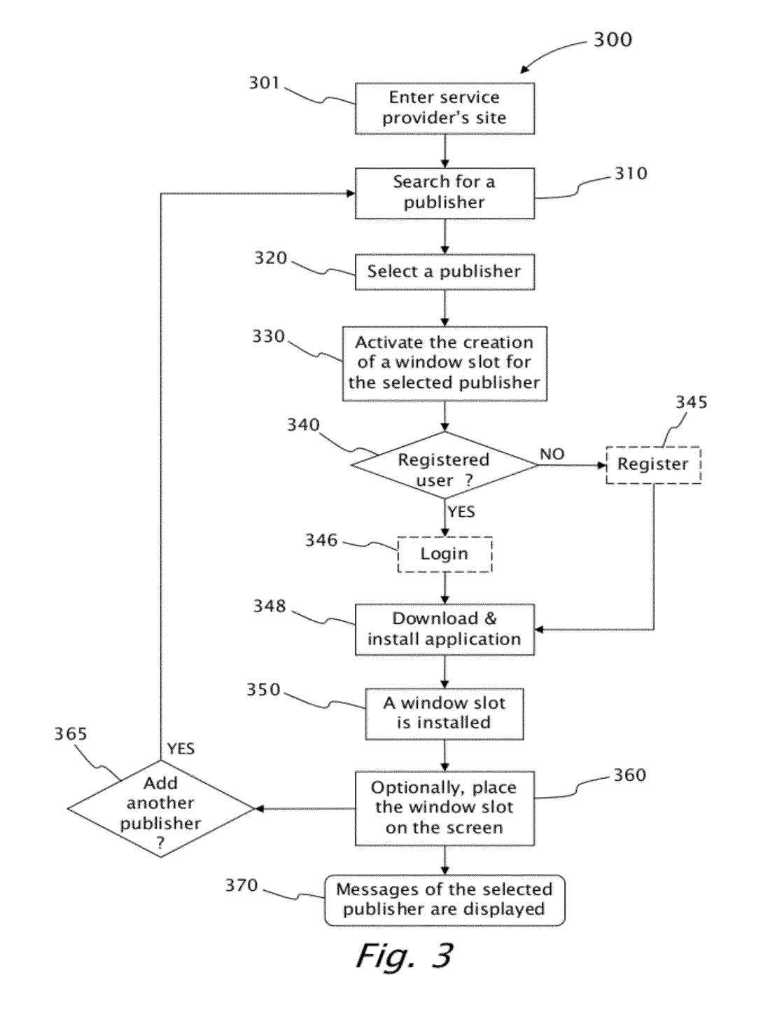

Reference is now made to FIG. 3, which is a schematic flow chart showing an example method 300 of a user 20 registering, selecting one or more publishers available on the bulletin messaging system, and downloading and installing a bulletin-window-slot 510 of a selected publisher 10, according to embodiments of the present invention. User 20 enters bulletin messaging system 100 in step 301, in order to select one or more new publishers 10 from DB 130 of bulletin messaging system 100. Once publisher 10 is logged into bulletin messaging system 100, process 300 proceeds as follows:
Step 310: search for a publisher.
   Optionally, user 20 searches for a publisher 10, using a search engine provided by server 102, using processor 110.
Step 320: select a publisher.
   User 20 selects a publisher 10, from which publisher 10, user 20 wished to receive messages.
Step 330: activate the creation of a window slot for the selected publisher.
   User 20 activates a process for creating a bulletin-window-slot 510 for the selected publisher 10, into which bulletin-window-slot 510 processor 110 will automatically deliver messages from the selected publisher 10.
Step 340: check if user 20 is a registered user.
   Typically, if user 20 is not a registered user of the services provided by bulletin messaging system 100, user 20 may register to the service in step 345. If just registering, go to step 348
Step 346: user 20 logs-in.
   Typically, user 20 is required to log-in to bulletin messaging system 100.
Step 348: download & install application.
   User 20 downloads and/or installs an application for creating and managing a bulletin-window-slot 510 and communication with messaging server 102. It should be noted that this is a one-time installation.
Step 350: a window slot is installed.
   The application program, installed in step 348, forms on screen 24 of user 20 a bulletin-window-slot 510 for the selected publisher 10, into which bulletin-window-slot 510, the publishers' management unit 112 will deliver messages from the selected publisher 10.
   In one example embodiment of the present invention, bulletin-window-slot 510 is created using the gadgets application of Windows® and RSS (Real Simple Syndication) technology. Messaging server 102 facilitates a user 20 to create an RSS channel in a user-friendly manner, as well as receiving data in a bulletin-window-slot 510, being a gadget, coupled with a particular publisher 10. In such embodiment, a bulletin-window-slot 510, being a gadget, is created by user 20 for each publisher 10, using an application provided by the service provider of bulletin messaging system 100.
   It should be noted that the present invention is not limited to the Windows® and RSS technology, and other operating systems and data transfer technologies known in the art are within the scope of the present invention.
Step 360: place the window slot on the screen.
   Optionally, user 20 positions bulletin-window-slot 510 of the selected publisher 10 on screen 24.
Step 365: check if user 20 wants to add another publisher.
   If user 20 wants to add another publisher and thereby a new bulletin-window-slot 510, go to step 310.
Step 370: the latest message of the selected publisher(s) 10 is displayed.
   Once bulletin-window-slot 510 of the selected publisher 10 is activated on screen 24, selected messages (typically the latest message) are displayed in bulletin-window-slot 510, wherein no further action is required from user 20. As the selected publisher 10 submits a new message or updates an existing message in DB 130, the message is automatically displayed inside bulletin-window-slot 510.
   It should be noted, that when the computer is restarted, except for connecting to network 50, user 20 is not required to perform any activity in order to receive messages from publisher 10 inside bulletin-window-slot 510 (provided that the operating system of the user's computer enables it).
   It should be further noted, that a user 20 may browse the internet site of the service provider of messaging server 102, and view messages posted by one or more publishers 10. Optionally, a user 20 may also select to receive more than one message to be displayed inside bulletin-window-slot 510 of that publisher 10. Optionally, a user 20 may also elect to receive messages from more than more than publisher 10 in a single bulletin-window-slot 510, using RSS technology.

In variations of the present invention, publishers' management unit 112 and users' management unit 114 are combined into a single management unit.

In variations of the present invention, user 20 may have control of one or more of the following parameters, relating to bulletin-window-slot 510: shape, font, advertisement location and other esthetic related parameters. User 20 may also select to eliminate advertisement, typically, in exchange for a fee.

In variations of the present invention, the publishers may allow free viewing of posted messages. In other variations of the present invention, the publishers may require that a user logs in using a common password. In yet other variations of the present invention, the publishers may require that a user logs in using a personal password.

In other variations of the present invention, the publishers pay subscription fees to the messaging service provider. Preferably, the subscription fee of a publisher is directly proportional to the number of users connected to receive messages from that publisher.

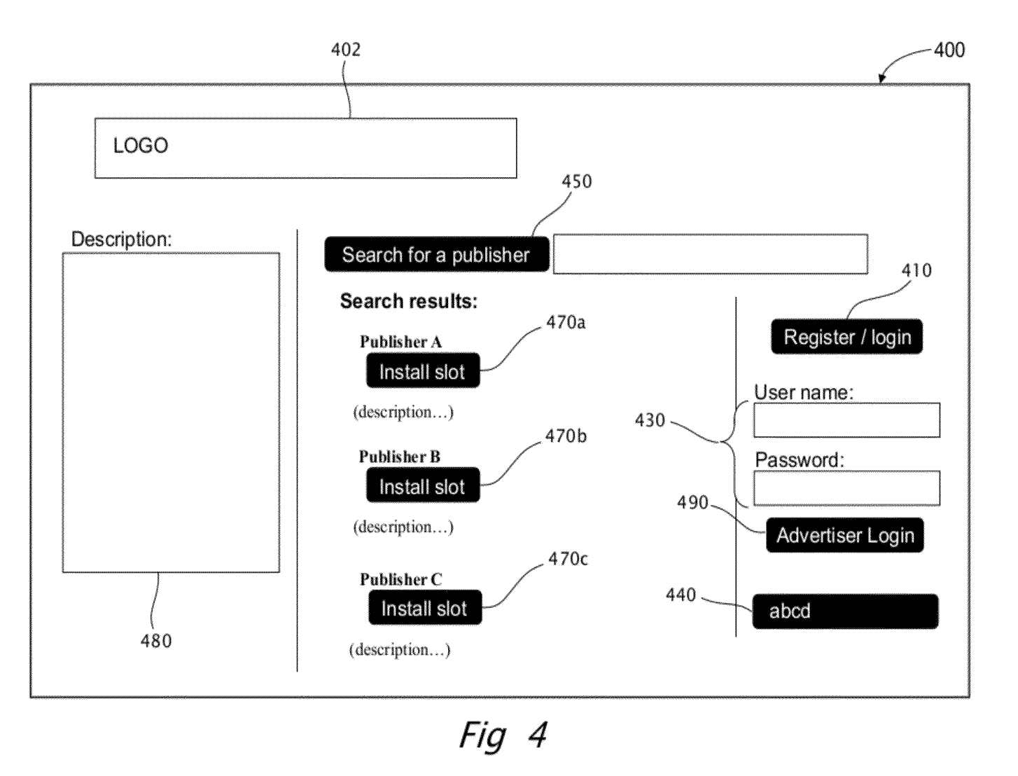

Example operating screens will now be shown, with no limitation on the layout and the content of the shown screens and the data fields thereof. Reference is made to FIG. 4, which shows an example home screen 400 of a messaging service provider, according to variations of the present invention. In this example, screen 400 includes an optional logo field 402 of the messaging service provider, a registration/log-in activation button 410 for registering a new publisher or logging-in of a registered publisher 10, login data fields 430 and other miscellaneous activation buttons 440. Screen 400 further includes a search field 450 for searching for a publisher by an occasional user 20 results in a list of publishers 10. Selecting a coupled publisher installation button 470, will download/install a bulletin-window-slot 510 for the selected publisher 10. Screen 400 may further include description field 480 for describing various items. Optionally, screen 400 further includes an advertiser's login button 490.

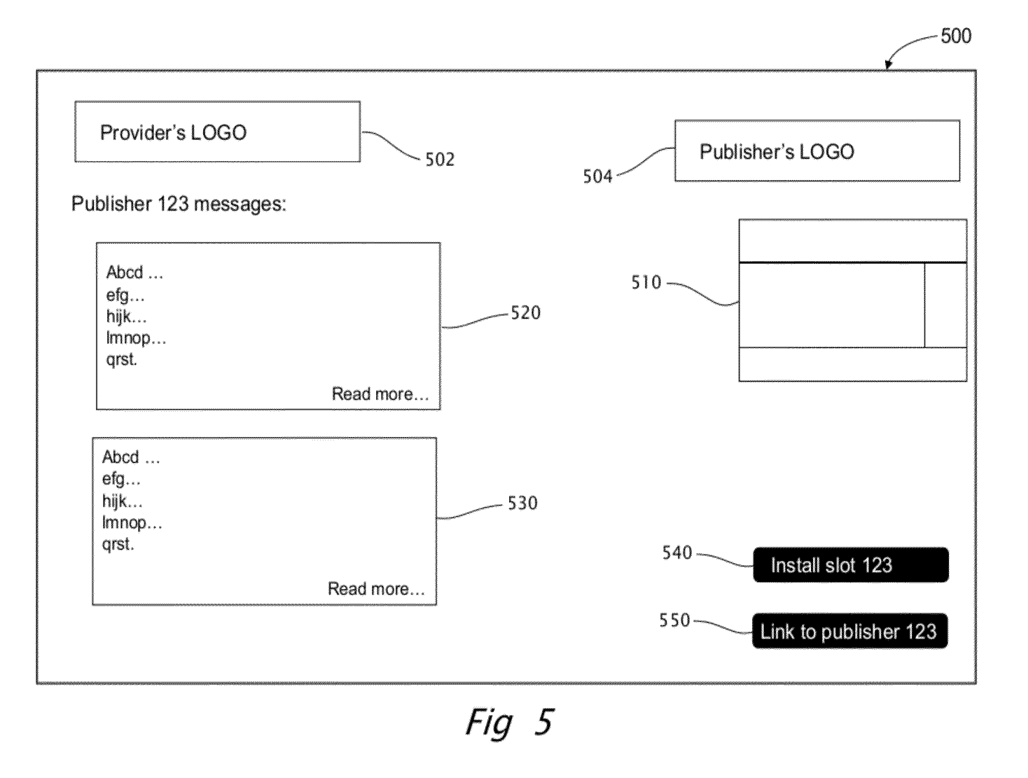

Reference is also made to FIG. 5, which shows a publishers' (10) message screen 500, according to variations of the present invention, which screen 500 is typically open to the public, browsing the internet site of the service provider of messaging server 102, and viewing messages posted by publisher 10. In this example, screen 500 includes an optional logo field 502 of the messaging service provider, an optional logo field 504 of the publisher, a bulletin-window-slot 510 for displaying messages of that publisher, a window slot installation button 540 (equivalent to button 470 in FIG. 4), one or more link buttons 550 for entering the publisher's (10) related web pages and a one or more fields (for example, fields 520 and 530) for outlining messages of that publisher.

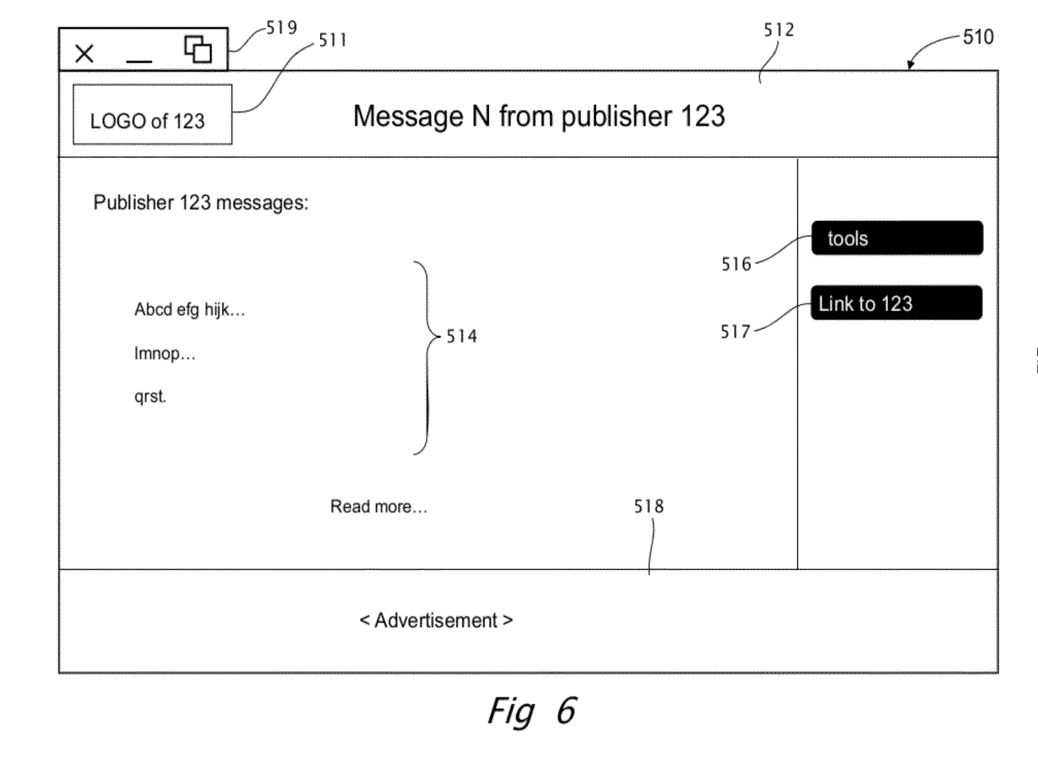

FIG. 6 shows in details an example bulletin-window-slot 510 for displaying messages of a selected publisher on screen 24 of a receiving device 22 of a user 20. In this example, bulletin-window-slot 510 includes a logo field 511 of the publisher, a message header field 512, one or more messages field 514, a tools activation button 516 for editing and changing design parameters of a bulletin-window-slot 510, one or more link buttons 517, an optional advertising field 518 for displaying the publisher's messages and a window control field 519.

An aspect of the present invention is to provide income for the messaging service provider via advertising means such as, with no limitation, using advertising field 518 (see FIG. 6). For example, an advertiser can select messages types and/or locations that when published, an additional advertising message will be displayed in bulletin-window-slot 510, in addition to the original message published by publisher 10, for example in region 518. The advertiser pays the service provider according the agreed parameters such as, the number of available bulletin-window-slots 510, number of days appearing, daily rate of appearing in a bulletin-window-slot 510, etc. The selected messages types can be for example, sport related, vehicles related, cosmetics/beauty related, quality of the environment related, etc. The selected messages location can be for example, all messages available in a particular city, or particular county, or particular state, etc.

Optionally, users that do not wish to be exposed to advertisements may subscribe to the messaging service, the subscription being typically a paid subscription. Similarly, publishers that do not wish to have advertisements shown in their bulletin-window-slot 510 may subscribe to the messaging service, the subscription being typically a paid subscription.

Optionally, other content types may be displayed in bulletin-window-slot 510, such as a search engine, gadgets, calendar, dictionaries, unit's convertor, etc., some of which content types may involve payments.

In variations of the present invention, the message presented in a publisher's bulletin-window-slot 510 may include contents, such as multimedia contents of a link to such contents. The content may include, with no limitation, music, movies, video clips, news, scrolling messages, etc., some of which content types may involve payments.

Optionally, bulletin-window-slot 510 may be used for chatting between a publisher 10 and one or more users 20.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. A messaging system for sending messages from a publisher (10) to a multiplicity of interconnected target users (20), comprising:
a) a bulletin messaging server (102), comprising:
i) a processor (110); and
ii) a database (130);
b) a computerized device (12) of a publisher (10); and
c) a computerized device (22) of a user (20),
wherein said bulletin messaging server (102) is in communication flow with said publisher's (10) computerized device (12) and with said user's computerized device (22);
wherein said bulletin messaging server (102) facilitates a publisher (10) to post a new message at a preconfigured location in said database (130);
wherein a target user (20) is enlisted to receive messages from said publisher (10); and
wherein said target user (20) receives a message from a publisher (10), in real time, in a designated bulletin window slot (510) on the screen (24) of said computerized device (22), upon said posting of a new message by said publisher (10).

2. The messaging system of claim 1, wherein the content of said message may be textual data, image data, video data, audio data, a gadget or a mixture thereof.

3. The messaging system of claim 1, wherein said target user (20) is one of a multiplicity of target users (20) of said publisher (10).

4. The messaging system of claim 1, wherein said user (20) places a multiplicity of said bulletin-window-slots (510) on said screen (24) of said computerized device (22), wherein each bulletin-window-slots (510) is coupled with a particular publisher (10).

5. The messaging system of claim 1, wherein said bulletin-window-slot (510) is created using the gadgets application of Windows® and RSS technology.

6. The messaging system of claim 1, wherein an advertisement is placed in a preconfigured location within said designated bulletin window slot (510) of one or more publishers (10).

7. The messaging system of claim 1, wherein said database (130) comprises a publishers' database (132) and a users' database (134).

8. A method of a user (20) enlisting to receive messages from a selected publisher (10), comprising the steps of:
a) providing messaging system including:
i) a bulletin messaging server (102) including:
A) a processor (110); and
B) a database (130);
ii) a computerized device (12) of a publisher (10); and
iii) a computerized device (22) of a user (20);
b) searching and selecting a publisher (10) from said database (130); and
c) creating a bulletin-window-slot (510) for receiving messages from said selected publisher (10),
wherein said bulletin messaging server (102) is in communication flow with said publisher's (10) computerized device (12) and with said user's computerized device (22); and
wherein said bulletin messaging server (102) facilitates a publisher (10) to post a new message at a preconfigured location in said database (130).

9. The method as in claim 8, wherein said user (20) first registers with the service provider that operates said bulletin messaging server (102).

10. The method as in claim 8, wherein said user (20) remains anonymous to said publisher (10).

11. The method as in claim 9, wherein said publisher (10) requires from a said user (20) to enter a password, in order to enlist to view messages posted by said publisher (10).

12. A method of publishing a message by a publisher (10) onto the bulletin-window-slot (510) of a pre-selected group of target users (20), the method comprising the steps of:
a) providing messaging system including:
i) a bulletin messaging server (102) including:
A) a processor (110); and
B) a database (130);
ii) a computerized device (12) of said publisher (10); and
iii) a computerized device (22) a of said target user (20);
b) placing a message in a designated location in said database (130); and
c) sending said message to all enlisted target users by said processor (110),
wherein said bulletin messaging server (102) is in communication flow with said publisher's (10) computerized device (12) and with said user's computerized device (22);
wherein said bulletin messaging server (102) facilitates a publisher (10) to post a new message at said designated location in said database (130);
wherein said publisher (10) first registers with the service provider that operates said bulletin messaging server (102); and
wherein said target user (20) is enlisted to receive messages from said publisher (10).

13. The method as in claim 12, wherein said target user (20) first registers with the service provider that operates said bulletin messaging server (102).

14. The method as in claim 13, wherein said publisher (10) requires that a password is entered by said target user (20) in order to enlist to view messages posted by said publisher (10).

15. The method as in claim 13, wherein said publisher (10) requires that said target user (20), enlisting to view messages posted by said publisher (10), be approved by said publisher (10).

16. The method as in claim 12, wherein said publisher (10) compensates the service provider that operates said bulletin messaging server (102), for messaging services rendered.

17. The method as in claim 12 further includes a step of placing an advertisement in a preconfigured location within said designated bulletin window slot (510) of said publisher (10).

18. The method as in claim 17, wherein the advertiser of said advertisement compensates the service provider that operates said bulletin messaging server (102).

19. The method as in claim 17, wherein the advertiser of said advertisement compensates said publisher (10).

20. The method as in claim 17, wherein the advertiser of said advertisement selects parameters of said advertisement according to a predetermined fee schedule, wherein said parameters are selected from a group including ad-type, location within said designated bulletin window slot (510), font and other esthetic related parameters.
